(19) United States
(12) Patent Application Publication
(10) Pub. No.: US 2016/0111923 A1
(43) Pub. Date: Apr. 21, 2016

(54) LAMINATION FOR A STATOR CORE OF AN ELECTRIC MACHINE

(71) Applicant: Electro-Motive Diesel, Inc., LaGrange, IL (US)

(72) Inventors: Joseph R. Bushen, Crest Hill, IL (US); Robert K. Lewton, Arlington Heights, IL (US)

(73) Assignee: Electro-Motive Diesel, Inc., LaGrange, IL (US)

(21) Appl. No.: 14/519,181

(22) Filed: Oct. 21, 2014

(51) Int. Cl. H02K 1/20; H02K 5/18

(52) U.S. Cl. CPC H02K 1/20; H02K 5/18

(57) ABSTRACT

A lamination for a stator core of an electric machine includes an outer periphery, and an inner periphery that is characterized by a plurality of teeth. The teeth are radially arranged so as to define slots therebetween. The lamination further defines an opening that is located between the outer periphery and the inner periphery. The lamination further defines a plurality of projections laterally extending into the opening, wherein the projections are configured to increase a surface area of the lamination located adjacent to the opening and increase a heat transfer capacity of the lamination. In another aspect of the present disclosure, such projections may also be located on the outer periphery of the lamination to increase the heat transfer capacity of the lamination.

### TECHNICAL FIELD

The present disclosure relates to thin plates of electrical grade steel that may or may not have an organic or inorganic coating for a stator core of an electric machine (herein known as laminations). More particularly, the present disclosure relates to a lamination with improved heat transfer properties.

### BACKGROUND

Typically, laminations for stator cores allow windings to be wound thereabout. With ever increasing performance demands from various electric machines, manufacturers are constantly developing compact configurations and/or newer designs of laminations. In meeting such performance demands, one area of concern that may arise is dissipation of heat that is generated by the electric machine at the time of operation.

Many systems and methods have been developed in the past to address the generation of heat during operation and accomplish a dissipation of the generated heat. For example, U.S. Publication 2013/0076168 describes a dynamoelectric machine that includes a stator and a rotor, each having a laminated core. The laminated cores of the stator and the rotor have axially extending cooling channels therein. However, providing cooling channels alone may be insufficient to dissipate the heat generated during operation of the electric machine.

Hence, there is a need for a lamination for a stator core that overcomes the aforementioned shortcomings.

### SUMMARY OF DISCLOSURE

In one aspect of the present disclosure, a lamination for a stator core of an electric machine includes an outer periphery, and an inner periphery that is characterized by a plurality of teeth. The teeth are radially arranged so as to define slots therebetween. The lamination further defines an opening that is located between the outer periphery and the inner periphery. The lamination further defines a plurality of projections laterally extending into the opening, wherein the projections are configured to increase a nominal perimeter of the lamination located adjacent to the opening and increase a heat transfer capacity of the lamination.

In another aspect of the present disclosure, such projections may also be located on the outer periphery of the lamination to further increase the heat transfer capacity of the lamination.

In another aspect of the present disclosure, embodiments are directed to a stator core of an electric machine, wherein the stator core employs a plurality of laminations disclosed herein.

Embodiments of the present disclosure are also directed to an electric machine employing the stator core disclosed herein.

Other features and aspects of this disclosure will be apparent from the following description and the accompanying drawings.

### BRIEF DESCRIPTION OF THE DRAWINGS

FIG. 1 is a top breakaway view of a lamination in accordance with an embodiment of the present disclosure;

FIG. 2 is a perspective view of an exemplary electric machine employing the lamination of FIG. 1;

FIG. 3 is a partial breakaway view of a stator assembly taken along section A-A′ of FIG. 2;

FIGS. 4-7 are top breakaway views of a lamination in accordance with other embodiments of the present disclosure; and

FIG. 8 is a top breakaway view of a lamination having an outer periphery defining projections thereon.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

The present disclosure relates to a lamination for a stator core of an electric machine. More particularly, the present disclosure relates to a lamination that is characterized with improved heat transfer properties.

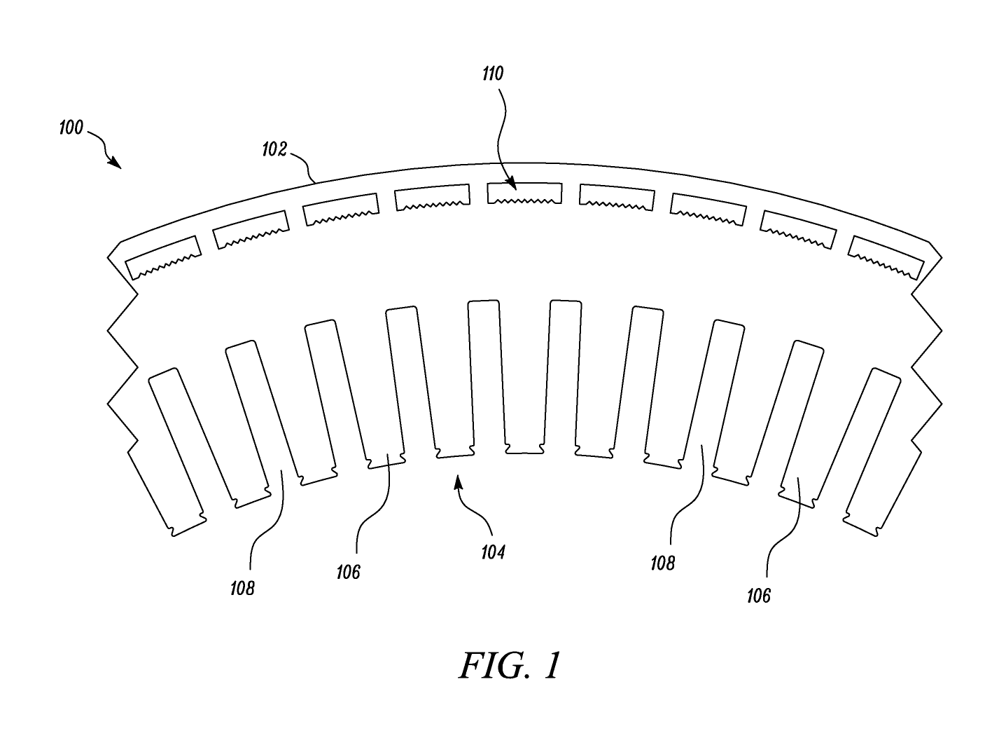

FIG. 1 shows a top breakaway view of a lamination 100 in accordance with an embodiment of the present disclosure. The lamination 100 may be formed from a magnetic material such as, but not limited to, Ferrous (Fe), Silicon Steel and the like. It will be appreciated that the lamination 100, shown and described in various embodiments herein, may be formed by performing a stamping or punching operation on a metal blank or sheet.

Although stamping or punching operation has been disclosed herein, one of ordinary skill will acknowledge that such operations are merely exemplary in nature and hence, non-limiting of this disclosure. Numerous other methods are readily known in the art and may be suitably employed in lieu of the stamping or punching operation to form the lamination 100 disclosed herein.

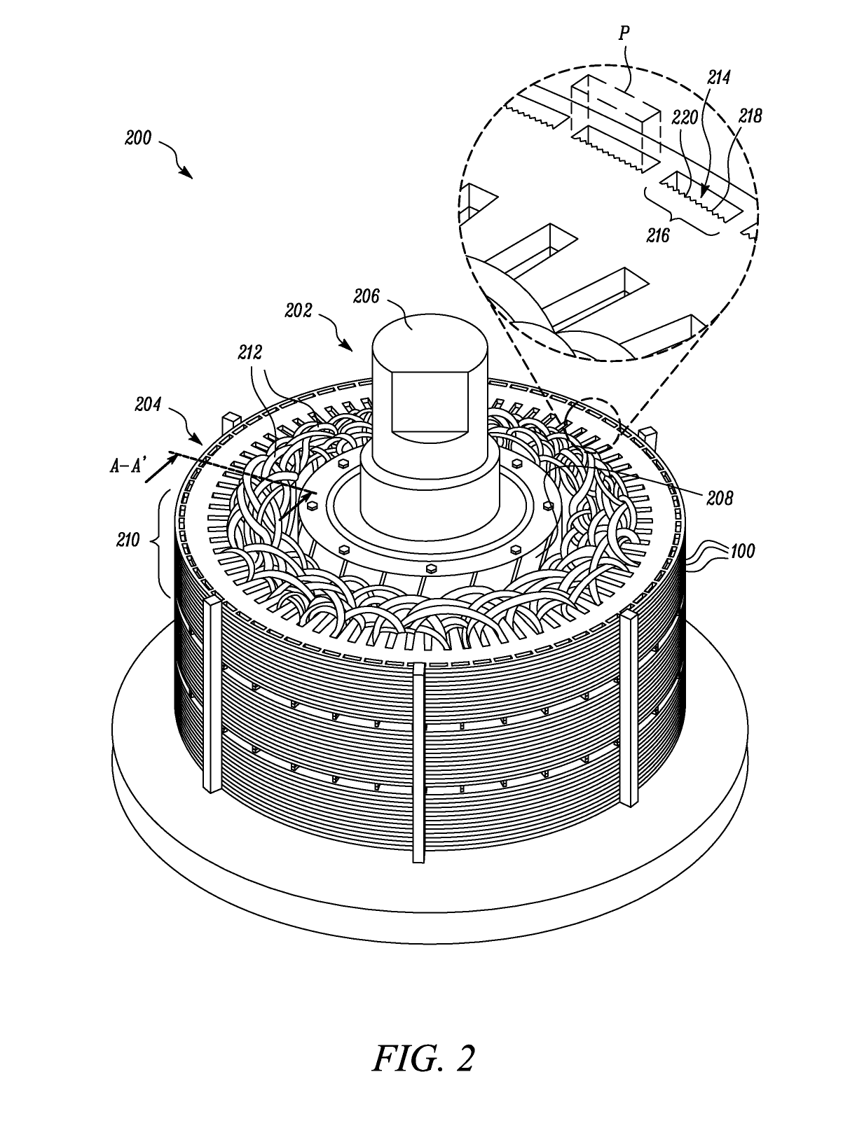

Moreover, certain coatings may be beneficially applied to the lamination 100 to impart certain desired properties to the lamination 100. For example, the coating may be applied to the laminations 100 to increase an amount of electrical resistance between adjacently placed laminations 100 (See FIG. 2), to reduce eddy currents, or to provide resistance against corrosion or rust. Such coatings may be organic or inorganic in type depending on specific requirements of an application that is associated with the lamination 100.

Referring to FIG. 1, the lamination 100 includes an outer periphery 102, and an inner periphery 104. The inner periphery 104 is characterized by a plurality of teeth 106 that are radially arranged to define slots 108 therebetween. The lamination 100 further defines an opening 110 (Nine openings 110 are shown in the illustrated embodiment of FIG. 1) that is located between the outer periphery 102 and the inner periphery 104. In the illustrated embodiment of FIG. 1, the opening 110 is rectangular in shape. As such, the opening 110 is configured to serve as a ventilation passage 214 explanation to which will be made later herein.

With continued reference to FIG. 1, the lamination 100 further defines a plurality of projections 112 laterally extending into the opening 110. These projections 112 are configured to increase a nominal perimeter P of the lamination 100 located adjacent to the opening 110 and hence, increase the surface area of the lamination 100 adjacent to the opening 110. In this manner, the heat transfer capacity of the lamination 100 may be consequently increased.

Referring to FIG. 2, a perspective view of an exemplary electric machine 200 employing the lamination 100 of FIG. 1 is shown. The electric machine 200 may be, for example, an alternator, a motor, a generator, and the like. In an embodiment, as shown in FIG. 2, the electric machine 200 may embody an alternator which may be used for producing alternating current (AC). The alternator may be of a type that is used in locomotives or large mining trucks, in which AC produced by the electric machine 200 may be used to power primary or auxiliary motors in locomotives or large mining trucks.

The electric machine 200 includes a rotor assembly 202, and a stator assembly 204. The rotor assembly 202 may include a shaft 206 drivably coupled to a prime mover such as an engine (not shown). The rotor assembly 202 may further include multiple electro-magnets 208 disposed on the shaft 206. When the prime mover rotates the shaft 206, the electro-magnets 208 disposed on the shaft 206 also rotate.

The stator assembly 204 is disposed about the rotor assembly 202. The stator assembly 204 includes a stator core 210 and windings 212 wound about the stator core 210. The stator core 210 includes multiple sets of laminations 100 that are stacked one above the other and placed in close tolerance with the rotor assembly 202. As shown in FIG. 2, the teeth 106 of the laminations 100 extend inwardly towards the rotor assembly 202 to allow the windings 212 to be wound thereon.

During operation of the electric machine 200, the electro-magnets 208 of the rotor assembly 202 are rotated to produce a magnetic field. This magnetic field may cut across the stator core 210 and produce an electromotive force (EMF) in the windings 212. This EMF may manifest itself as alternating current in the windings 212 of the stator assembly 204.

As known to a person having ordinary skill in the art, during production of EMF in the stationary set of conductors, the stationary set of conductors offers electrical resistance. This electrical resistance offered is based on the materials constituting the stationary set of conductors by virtue of its inherent electrical resistance property. This electrical resistance manifests itself as heat in the electric machine 200. Hence, constant production of EMF or alternating current in the windings 212 will cause heat to be generated. Also, this production of heat may be significantly large in the case of heavy and/or large electric machines.

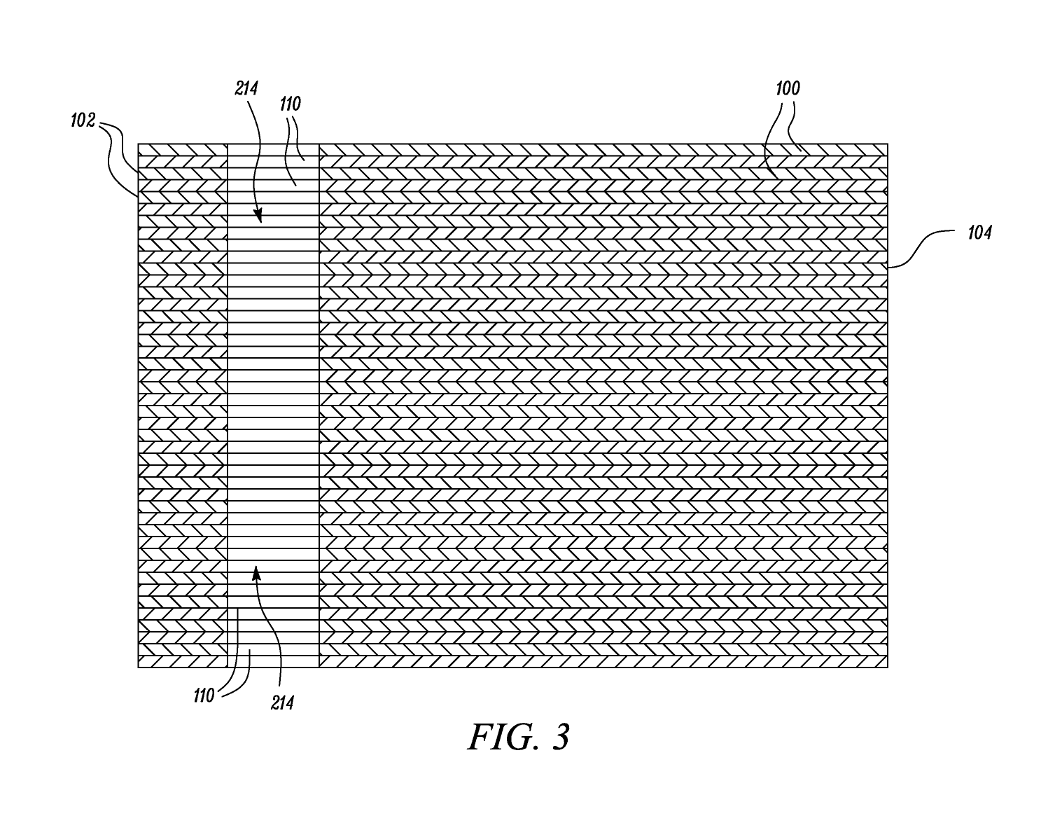

FIG. 3 is a partial breakaway view of a stator assembly 204 taken along sectional line A-A′ of FIG. 2. For the purposes of illustration and better understanding of this disclosure, one set of stacked laminations 100 has been depicted without the windings 212 thereon in FIG. 3. Moreover, a portion of the stator assembly 204 and the stacked laminations 100 therein has been eliminated from the illustration of FIG. 3. However, one of ordinary skill will acknowledge that an electric machine 200 may include any number or sets of stacked laminations 100 with windings 212, disposed above and below the stacked laminations 100 of FIG. 3.

Referring to FIGS. 2 and 3, the openings 110 of mutually adjacent laminations 100 are disposed in alignment to define a ventilation passage 214. Moreover, as each of the projections 112 is configured to increase a nominal perimeter P of the lamination 100 and hence, the surface area of the lamination that is located adjacent to the opening 110 (See FIG. 2). The projections 112 thus increase an amount of thermal communication that is possible between the respective lamination 100 and the ventilation passage 214. In the illustrated embodiments of FIGS. 2 and 3, the projections 112 are configured to define a ridge pattern 216 adjacent to the opening 110. This ridge pattern 216 may include crests 218 and troughs 220 alternating with one another and such a configuration may present an increased perimeter P and/or surface area of the lamination 100 adjacent to the ventilation passage 214. Consequently, the lamination 100 may be imparted with a larger heat transfer capacity to accomplish a larger and/or quicker rate of heat dissipation from the laminations 100 into the surroundings.

Although a ridge pattern 216 with crests 218 and troughs 220 has been disclosed herein, the lamination 100 may be formed to include other configurations such as, for e.g., a curvilinear configuration in the perimeter P of the lamination 100 adjacent to the opening 110. Further, a density of the crests 218 and troughs 220 in the ridge pattern 216, i.e., per unit length of the perimeter P of the lamination 100 may be suitably selected depending on feasibility in manufacturing and/or specific requirements of an application.

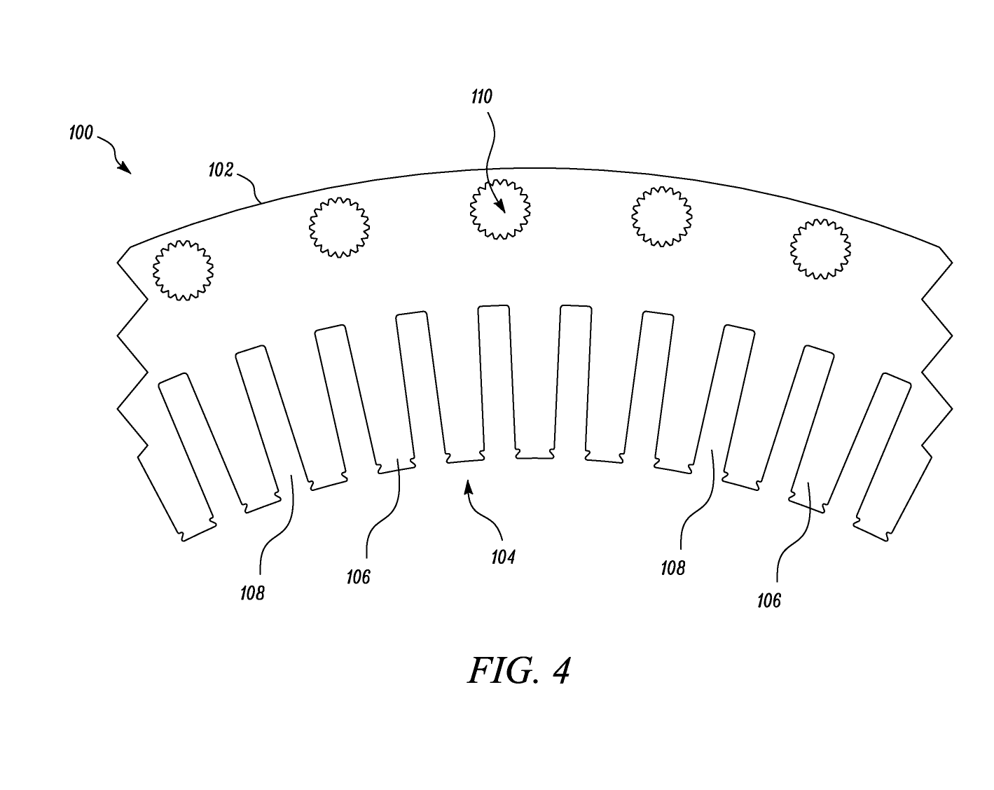

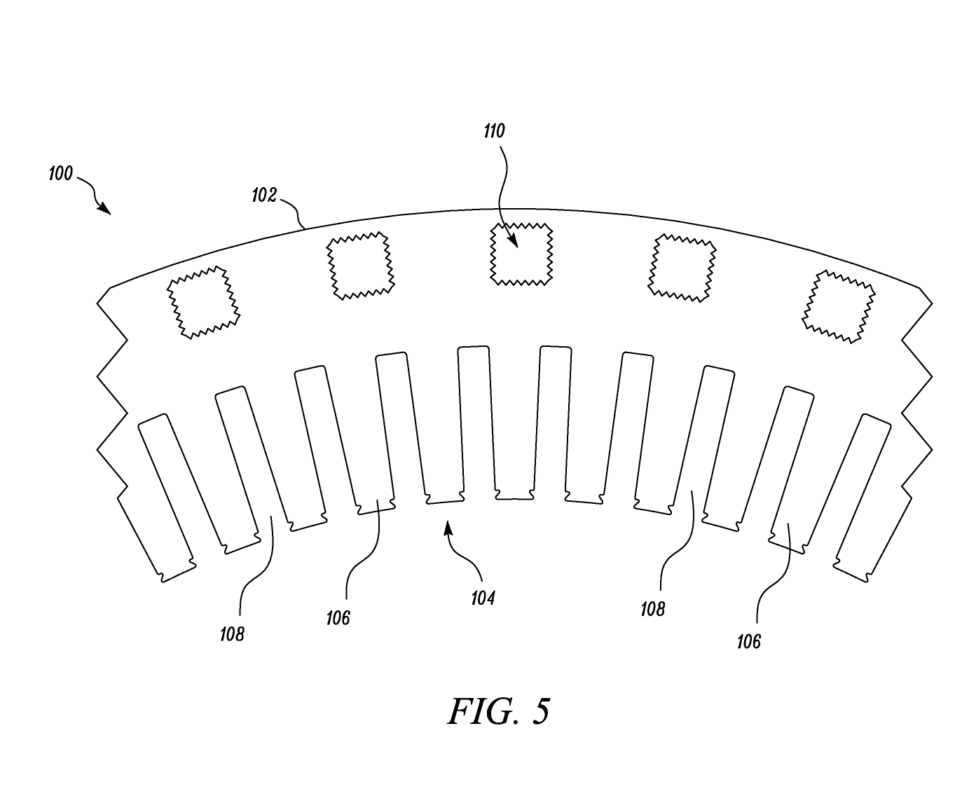

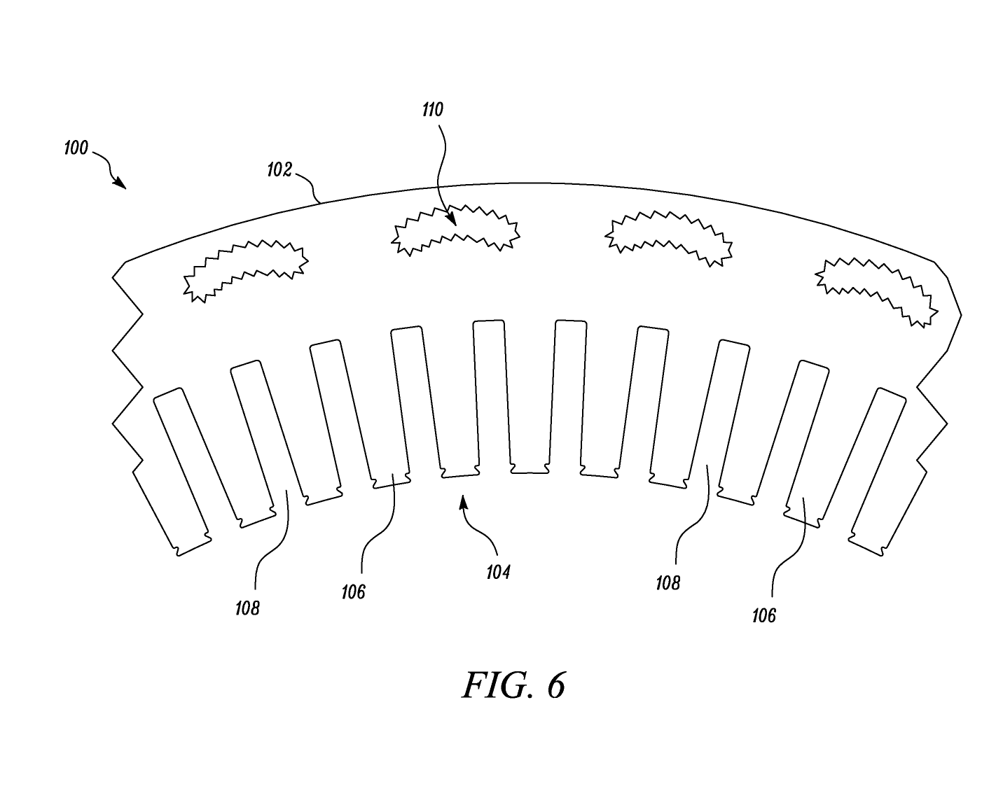

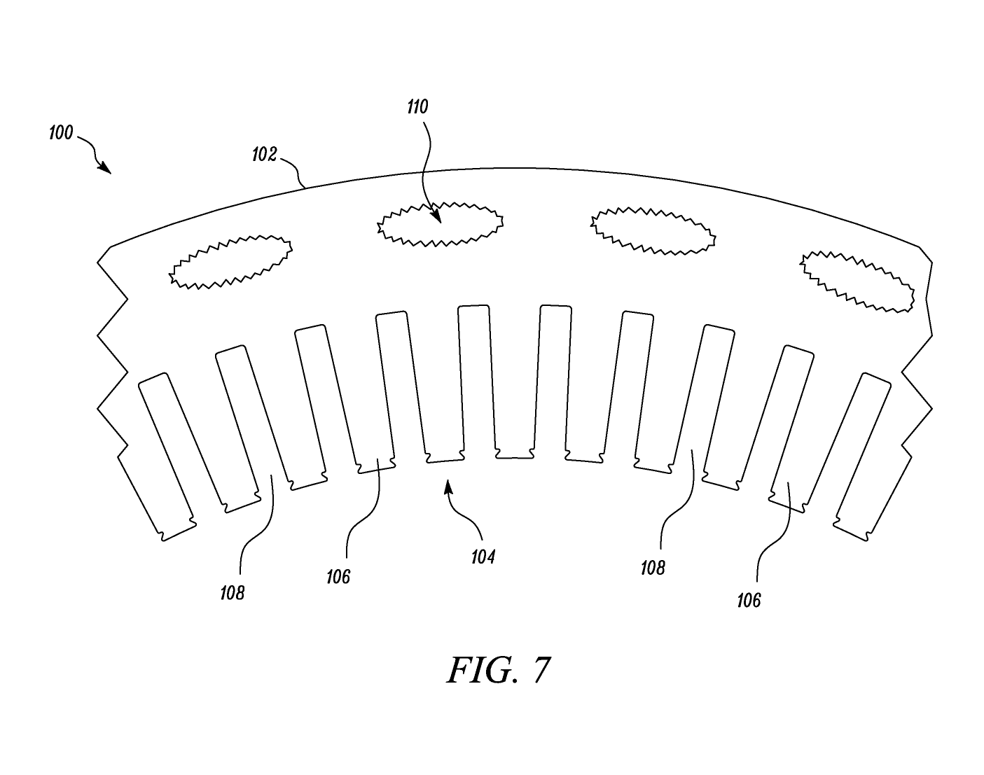

Although a rectangular shaped opening 110 has been disclosed in the embodiments of FIGS. 1-3, one of ordinary skill in the art will acknowledge that other shapes may be suitably adopted in lieu of the rectangular shape. FIGS. 4-7 show top views of a lamination 100 in accordance with various embodiments of the present disclosure. As shown in FIG. 4, the lamination 100 defines a square shaped opening 110. As shown in FIG. 5, the lamination 100 defines a circular shaped opening 110, while in FIG. 6; the lamination 100 defines an elliptical shaped opening 110. Further, as shown in FIG. 7, the lamination 100 defines a reniform or kidney shaped opening 110. Moreover, as exemplarily illustrated in FIGS. 4-7, the projections 112 may be beneficially formed in openings 110 of any shape to improve the heat transfer capacity of the respective lamination 100.

Although some shapes have been illustrated for the openings 110, one may beneficially contemplate various other shapes for forming the opening 110. Also, it can be contemplated to include similar or various dissimilar shapes of openings 110 in a single lamination 100 without deviating from the scope or the spirit of the present disclosure. Moreover, a number of openings 110 depicted in various embodiments herein is merely exemplary in nature and hence, non-limiting of this disclosure. Therefore, a number of openings 110 to be defined on each of the laminations 100 may be suitably selected depending on specific requirements of an application.

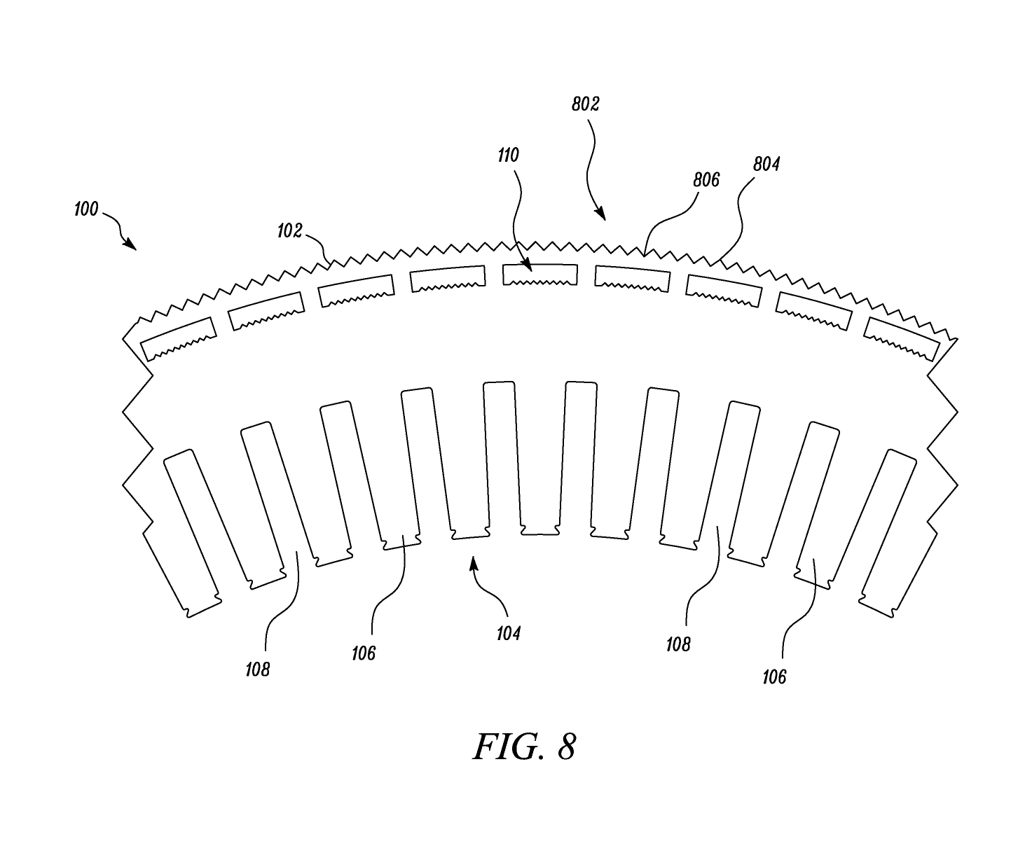

FIG. 8 illustrates a top breakaway view of a lamination 100 in accordance with another embodiment. As shown in the illustrated embodiment of FIG. 8, the lamination 100 may further include projections 802 located at the outer periphery 102 of the lamination 100. These projections 802 laterally extending away from the outer periphery 102 to define crests 804 and troughs 806 that are configured to alternate with each other. The projections 802 disclosed herein also serve to increase heat transfer capacity of the lamination 100.

One of ordinary skill in the art can contemplate to beneficially provide one or both types of projections 112, 802 disclosed herein in a given lamination. It is hereby envisioned that by providing both types of projections 112 and 802 on a given lamination, the lamination may be imparted with improved heat transfer properties that may allow a faster rate of heat dissipation therefrom.

Various embodiments disclosed herein are to be taken in the illustrative and explanatory sense, and should in no way be construed as limiting of the present disclosure. All directional references (e.g., above, below, upper, lower, top, bottom, vertical, horizontal, inward, outward, radial, upward, downward, left, right, leftward, rightward, L.H.S, R.H.S, clockwise, and counter-clockwise) are only used for identification purposes to aid the reader's understanding of the present disclosure, and may not create limitations, particularly as to the position, orientation, or use of the devices and/or methods disclosed herein. Joinder references (e.g., attached, affixed, coupled, engaged, connected, and the like) are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

Embodiments of the present disclosure have applicability for implementation and use in dissipating heat generated in electric machines during operation.

One of ordinary skill in the art will acknowledge that various components in an electric machine 200 typically produce heat during operation. As disclosed earlier herein, during operation of the electric machine 200, current is produced in the windings 212 of the stator assembly 204. An intrinsic property of the windings 212 is to offer electrical resistance to the current flowing therein. This electrical resistance manifests itself as heat and the heat may be detrimental to the service life of the windings 212 and also several other components within the electric machine 200 such as, but not limited to, bearings and insulating claddings. In some cases, this heat may result in a melting of the insulation claddings of wires or even cause a fire within the electric machine 200. Hence, heat generated within the electric machine 200 may require dissipation to prevent components within the electric machine 200 from deteriorating.

Further, as known to a person having ordinary skill in the art, air exists in spaces within the electric machine 200. For ease in understanding the present disclosure, these spaces may be regarded as the space present between the rotor assembly 202 and the stator assembly 204. Air present in this space may be forced out centrifugally due to momentum transfer by the high speed rotation of the rotor assembly 202. This air may be used as a medium to carry heat from the abutting rotor assembly 202 and stator assembly 204.

The mutually aligned openings 110 from adjacent laminations 100 together define the ventilation passage 214 through which air may carry the heat and transfer it to the atmosphere. Moreover, electric machines are typically force-ventilated by way of fan blades that are built into the rotor assembly 202 of the electric machine 200. These fan blades may force atmospheric air through the ventilation passages 214 to uniformly cool down the electric machine 200. Therefore, use of the laminations 100 disclosed herein may allow the electric machine 200 to cool down during an operation and also maintain a temperature within the electric machine 200 within pre-defined or acceptable limits.

Further, with use of the laminations 100 in electric machines, costs incurred with use of previously known cooling systems may be offset. Moreover, frequent repairs and/or replacement of components within the electric machine 200 may be avoided. Furthermore, down times associated with repairs and replacement of components within the electric machine 200 may be reduced.

The laminations 100 disclosed herein may be manufactured using conventionally known processes such as, but not limited to, stamping, punching, laser cutting, or performing a cast extrusion process on sheet metal blanks Such manufacturing processes are typically known to be economical and may hence; allow a manufacturer to produce the laminations 100 of the present disclosure in an economical manner.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A lamination for a stator core of an electric machine, the lamination comprising:
an outer periphery;
an inner periphery characterized by a plurality of teeth, the plurality of teeth being radially arranged so as to define slots therebetween; and
an opening located between the outer periphery and the inner periphery, wherein the lamination defines a plurality of projections laterally extending into the opening.

2. The lamination of claim 1, wherein each of the projections is configured to increase a surface area of the lamination located adjacent to the opening.

3. The lamination of claim 1, wherein the opening is one of rectangular, square, circular, elliptical, and reniform in shape.

4. The lamination of claim 1, wherein the projections are configured to define a ridge pattern adjacent to the opening, the ridge pattern comprising crests and troughs alternating with one another.

5. A stator core employing the lamination-of claim 1, wherein a plurality of laminations are stacked one above another.

6. The stator core of claim 5, wherein the openings of mutually adjacent laminations are disposed in alignment to define a ventilation passage.

7. The stator core of claim 6, wherein the projections from each lamination are configured to increase an amount of thermal communication between the respective lamination and the ventilation passage.

8. A stator core of an electric machine, the stator core comprising:
a plurality of laminations stacked one above another and disposed about a centric axis, wherein each of the laminations includes:
an outer periphery;
an inner periphery characterized by a plurality of teeth, the plurality of teeth being radially arranged so as to define slots therebetween; and
an opening located between the outer periphery and the inner periphery, wherein the lamination defines a plurality of projections laterally extending into the opening.

9. The stator core of claim 8, wherein each of the projections is configured to increase a surface area of the lamination located adjacent to the opening.

10. The stator core of claim 8, wherein the opening is one of rectangular, square, circular, elliptical, and reniform in shape.

11. The stator core of claim 8, wherein the projections are configured to define a ridge pattern adjacent to the opening, the ridge pattern comprising of crests and troughs alternating with one another.

12. The stator core of claim 11, wherein the openings of mutually adjacent laminations are disposed in alignment to define a ventilation passage.

13. The stator core of claim 12, wherein the projections from each lamination are configured to increase an amount of thermal communication between the respective lamination and the ventilation passage.

14. An electric machine comprising:
a rotor assembly disposed about a centric axis;
a stator assembly disposed about the rotor assembly, the stator assembly comprising:
a stator core comprising:
a plurality of laminations stacked one above another, wherein each of the laminations includes:
an outer periphery;
an inner periphery characterized by a plurality of teeth, the plurality of teeth being radially arranged so as to define slots therebetween; and
an opening located between the outer periphery and the inner periphery, wherein the lamination defines a plurality of projections laterally extending into the opening.

15. The electric machine of claim 14, wherein each of the projections is configured to increase a surface area of the lamination located adjacent to the opening.

16. The electric machine of claim 14, wherein the opening is one of rectangular, square, circular, elliptical, and reniform in shape.

17. The electric machine of claim 14, wherein the projections are configured to define a ridge pattern adjacent to the opening, the ridge pattern comprising of crests and troughs alternating with one another.

18. The electric machine of claim 17, wherein the openings of mutually adjacent laminations are disposed in alignment to define a ventilation passage.

19. The electric machine of claim 18, wherein the projections from each lamination are configured to increase an amount of thermal communication between the respective lamination and the ventilation passage.

20. A lamination for a stator core of an electric machine, the lamination comprising:
an inner periphery characterized by a plurality of teeth, the plurality of teeth being radially arranged so as to define slots therebetween; and
an outer periphery characterized by a plurality of projections thereon, the projections laterally extending away from the outer periphery to define crests and troughs alternating with each other.
